(19) United States
(12) Patent Application Publication
(10) Pub. No.: US 2019/0062206 A1
(43) Pub. Date: Feb. 28, 2019

(54) STRENGTHENED GLASS PLATE

(71) Applicant: AGC Inc., Chiyoda-ku (JP)

(72) Inventors: Satoshi OGAMI, Tokyo (JP); Yoshitaka SAIJO, Tokyo (JP)

(73) Assignee: AGC Inc., Chiyoda-ku (JP)

(21) Appl. No.: 16/173,416

(22) Filed: Oct. 29, 2018

Related U.S. Application Data
(62) Division of application No. 15/497,303, filed on Apr. 26, 2017.

(30) Foreign Application Priority Data
Apr. 27, 2016 (JP) 2016-089796

(51) Int. Cl. C03C 21/00

(52) U.S. Cl. CPC C03C 21/005; C03C 2204/08; C03C 21/00

(57) ABSTRACT

A strengthened glass plate includes: a first functional layer that is provided in a first main surface of the strengthened glass plate; and a second functional layer that is provided in a second main surface of the strengthened glass plate. When a stress in a tensile stress layer is designated as CT, the following relation regarding the CT is satisfied: CT>0.8×[−38.7×ln(t/1000)+48.2], where t is a plate thickness [μm], CS is a compressive stress [MPa] in an outermost surface, and DOL is a depth [μm] from a glass surface to a point where the compressive stress reaches zero in a thickness direction.

### CROSS-REFERENCE TO RELATED APPLICATIONS

This application claims priority from Japanese Patent Application No. 2016-089796 filed on Apr. 27, 2016, the entire subject matter of which is incorporated herein by reference.

### BACKGROUND OF THE INVENTION

### Technical Field

The present invention relates to a strengthened glass plate, and particularly relates to a chemically strengthened glass plate.

### Background Art

Glass is often used for display portions or housing bodies in electronic devices such as mobile phones or smart phones. So-called chemically strengthened glass is used in order to increase strength of the glass. In the chemically strengthened glass, a surface layer is formed in a surface of the glass by ion exchange to thereby increase strength of the glass. The surface layer of strengthened glass such as chemically strengthened glass contains a compressive stress layer at least on the glass surface side. Compressive stress caused by ion exchange occurs in the compressive stress layer. The surface layer of the strengthened glass may contain a tensile stress layer on an inner side of the glass. The tensile stress layer where tensile stress occurs is located next to the compressive stress layer. The strength of the strengthened glass is associated with a stress of the surface layer formed therein, or depth of the compressive stress layer in the surface. For development of the strengthened glass or quality control in producing the strengthened glass, it is therefore important to measure the stress of the surface layer, the depth of the compressive stress layer or the distribution of stress.

Examples of a technique for measuring stress in a surface layer of strengthened glass may include a technique (hereinafter referred to as nondestructive measuring technique) in which compressive stress in a surface layer is measured in a nondestructive manner using a light waveguide effect and a photoelastic effect when the refractive index of the surface layer of the strengthened glass is higher than the refractive index of the inside thereof. According to the nondestructive measuring technique, monochromatic light is made incident on the surface layer of the strengthened glass to generate a plurality of modes due to the light waveguide effect. Light having a fixed beam trajectory is extracted in each mode, and is made to form an emission line corresponding to the mode by a convex lens. The number of emission lines formed corresponds to the number of the modes.

In addition, the nondestructive measuring technique has a configuration in which emission lines of two kinds of light components as to the light extracted from the surface layer can be observed. The two kinds of light components have horizontal and vertical light oscillation directions with respect to an emission surface, respectively. Light of a mode 1 lowest in degree is characterized by passing through, of the surface layer, a closest part to the surface. By use of this characteristic, refractive indexes of the two kinds of light components are calculated from positions of emission lines of the light components corresponding to the mode 1, respectively. Stress near the surface of the strengthened glass is obtained from a difference between the calculated refractive indexes of the two kinds of light components and a photoelastic constant of the glass (for example, see Patent Literature 1).

On the basis of the principle of the aforementioned nondestructive measuring technique, another method has been proposed. In the method, stress in an outermost surface of glass (hereinafter referred to as surface stress value) is obtained by extrapolation from positions of emission lines corresponding to a mode 1 and a mode 2. In addition, on the assumption that a refractive index distribution in a surface layer varies linearly, depth of a compressive stress layer is obtained from the total number of emission lines (for example, see Non-Patent Literature 1).

Further, it has been also proposed to apply improvement to a surface stress measuring apparatus based on the aforementioned nondestructive measuring technique, so that surface stress of glass low in light transmittance in a visible range can be measured by use of infrared rays as a light source (for example, see Patent Literature 2).

In addition, a light input/output member (prism) is used for making monochromatic light incident on strengthened glass or emitted from the glass during measurement, and refraction liquid having a refractive index between a refractive index of the prism and a refractive index of the glass is used in an interface between the prism and the glass. Particularly, it has been proposed to use refraction liquid having a refractive index close to the refractive index np of the prism (for example, see Patent Literature 3). That is, nf≈(np+ngs)/2 or ng<nf≈np when ngs is a refractive index in an outermost surface of a region where compressive stress has been applied to the strengthened glass, and nf is a refractive index in the liquid brought into contact with the glass surface during measurement.

However, strengthened glass is expected to be applied to various fields. Thus, it can be considered that a layer having a special function such as an antiglare effect or an antimicrobial effect is provided in a surface of strengthened glass. In such a case, optical uniformity in the surface of the strengthened glass may be lost so that the refractive index in the surface layer cannot be measured accurately or at all. When a functional layer is provided only on one side, it will go well if another surface where no functional layer is provided is measured artificially. However, when functional layers are provided in two main surfaces, that is, front and back surfaces of a glass plate, or when a functional layer is provided in the front surface while glass is not exposed in the back surface, the refractive index cannot be measured accurately. Thus, there is a problem that a strengthened glass plate superior in strength cannot be provided.
Patent Literature 1: JP-A-S53-136886
Patent Literature 2: JP-A-2014-28730
Patent Literature 3: US-B2-9109881
Non-Patent Literature 1: Yogyo-Kyokai-Shi (Journal of the Ceramic Society of Japan), 87{3}, 1979

### SUMMARY OF THE INVENTION

In an embodiment of the present invention, a strengthened glass plate which has functional layers in both main surfaces, that is, front and back surfaces, respectively, and which is superior in strength, is provided.

A strengthened glass plate in one aspect of the present invention includes:

a first functional layer that is provided in a first main surface of the strengthened glass plate; and

a second functional layer that is provided in a second main surface of the strengthened glass plate, and

when a stress in a tensile stress layer is designated as CT, the CT being obtained by the following formula (1),

$$CT = \frac{CS \times DOL}{t - 2 \times DOL} \qquad ( 1 )$$

the following relation regarding the CT is satisfied:

CT>0.8×[−38.7×ln(t/1000)+48.2]

wherein t is a plate thickness [μm], CS is a compressive stress [MPa] in an outermost surface, and DOL is a depth [μm] from a glass surface to a point where the compressive stress reaches zero in a thickness direction.

In addition, a strengthened glass plate in another aspect of the present invention includes:

a first functional layer that is provided in a first main surface of the strengthened glass plate; and

a second functional layer that is provided in a second main surface of the strengthened glass plate, and

when the following relation is satisfied based on characteristic values of a strengthened layer that has been chemically strengthened:

$$[ \frac{CS \times DOL}{t - 2 \times DOL} ] / [ \frac{2 \times {\int }_{0}^{DOL} CS ( x ) dx}{t - 2 \times DOL} ] \geq 85 \%$$

the following relation regarding a specific energy density rE is satisfied:

rE>0.8×[23.3×t/1000+15]

wherein the rE is obtained by the following formula (2):

$$rE = \frac{CT \times {( t - 2 \times DOL )}^{2}}{1000 \times t} \qquad ( 2 )$$

and t is a plate thickness [μm], CS is a compressive stress [MPa] in an outermost surface, CS(x) is a compressive stress [MPa] in depth x [μm], and DOL is a depth [μm] from a glass surface to a point where the CS(x) reaches zero in a thickness direction.

It is possible to provide a strengthened glass plate which has functional layers in both main surfaces, that is, front and back surfaces, respectively, and which is superior in strength.

### BRIEF DESCRIPTION OF THE DRAWINGS

FIG. 1 is a sectional view schematically showing a strengthened glass plate according to an embodiment of the present invention.

FIG. 2 is a view showing a surface refractive index measuring apparatus according to an embodiment of the present invention.

FIG. 3 is a flow chart showing an example of a measuring method according to an embodiment of the present invention.

FIG. 4 is a flow chart showing the measuring method according to an embodiment of the present invention.

FIG. 5 is a diagram showing functional blocks of an arithmetic operation portion 70 of a surface refractive index measuring apparatus 1.

FIG. 6A to FIG. 6F are photos of emission lines in Comparative Examples 1 to 6, respectively.

FIG. 7A to FIG. 7F are graphs showing brightness of emission lines in which brightness on the upper side of the photo of the emission lines is expressed by 256 colors in Comparative Examples 1 to 6, respectively.

FIG. 8A to FIG. 8D are photos of emission lines in Examples 1 to 4, respectively.

FIG. 9A to FIG. 9D are graphs showing brightness of emission lines in which brightness on the upper side of the photo of the emission lines is expressed by 256 colors in Examples 1 to 4, respectively.

### DETAILED DESCRIPTION OF THE INVENTION

An embodiment of the present invention will be described below with reference to the drawings. In each drawing, constituent parts the same as those in the other drawings are referenced correspondingly, and redundant description thereof may be omitted.

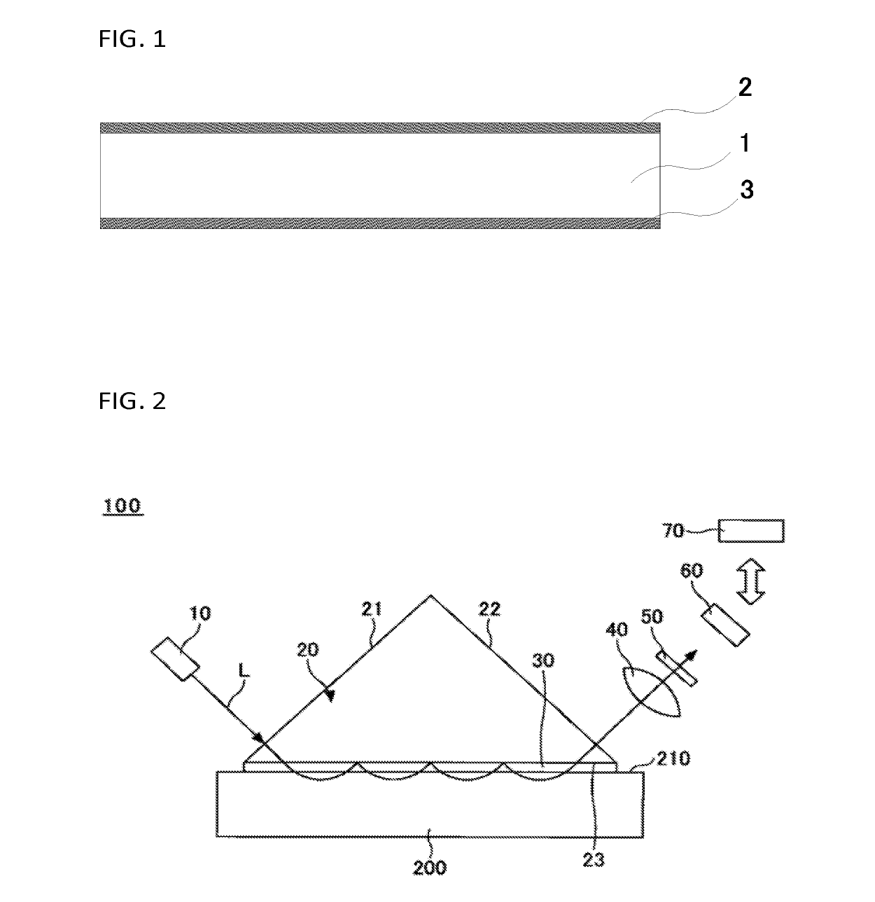

FIG. 1 is a sectional view schematically showing a strengthened glass plate according to an embodiment of the present invention. As shown in FIG. 1, a strengthened glass plate 1 according to the embodiment of the present invention has a first functional layer 2 in a first main surface, and has a second functional layer 3 in a second main surface. The first functional layer 2 and the second functional layer 3 may be physically or chemically similar layers or different layers. Each functional layer in the embodiment is a layer in which the surface of the glass plate itself has been physically or chemically modified. For example, each functional layer may be a roughened layer having an arithmetic average roughness Ra (JIS B 0601:2001) of 0.1 μm or more, or a layer doped with element(s) other than elements of a matrix composition of the glass plate 1. The arithmetic average roughness Ra in the roughened layer is, for example, 2 μm or less.

In addition, each functional layer in the embodiment is a layer that provides optical disturbance, or a layer having a different composition from the matrix composition of glass and covering the surface of the glass plate. At least one of the functional layers is preferably a layer that provides optical disturbance. One of the functional layers does not have to be a layer that provides optical disturbance, as long as a stress value cannot be measured from the glass surface in a state where the surface of the glass plate is not exposed. For example, when strengthened glass in which tin (Sn) has been diffused in a surface of soda lime glass is measured, assuming that a refractive index ngb of the glass before a chemically strengthening step is 1.518, and a refractive index ngs in the outermost surface reaches 1.525 due to the chemically strengthening step, the contrast of emission lines is too poor to measure stress accurately when a refractive index of liquid brought into contact with the glass surface is around 1.64 as in a background-art apparatus (for example, FSM-6000 made by Orihara Industrial Co., Ltd.). It has been therefore impossible to produce a strengthened glass plate in which layers that provide optical disturbance to chemically strengthened layers as described previously are present in both main surfaces and which is superior in strength. Even as for a strengthened glass plate in which stress cannot be measured substantially due to printing, coating or the like on one of chemically strengthened surfaces while a layer providing optical disturbance is present in the other chemically strengthened layer, it has been impossible to produce the strengthened glass plate with superior strength.

However, when ngb<nf≤ngs+0.005 where ngb is a refractive index in a non-strengthened region, ngs is a refractive index in a strengthened region where compressive stress has been applied, and of is a refractive index of the liquid brought into contact with the glass surface during measurement, and when a distance between a prism and the strengthened glass surface is set to be 5 microns or less, the contrast of emission lines is improved dramatically in the measurement so that stress can be measured accurately. Further, more preferably, the following relation is satisfied: ngb+0.005≤nf≤ngs+0.005. In addition, especially preferably, the absolute value of the difference between the refractive index nf of the liquid and the refractive index ngs of the strengthened region where compressive stress has been applied is 0.005 or less.

The strengthened glass plate 1 has compressive stress layers in its main surfaces. Compressive stress caused by ion exchange occurs in the compressive stress layers. The strengthened glass plate 1 includes tensile stress layers on the inner side of the glass. The tensile stress layers are located next to the compressive stress layers. Tensile stress occurs in the tensile stress layers. The strength of the strengthened glass plate is associated with stress of the formed compressive stress layers and formed tensile stress layers, or the depths of the compressive stress layers in the surfaces. The compressive stress layers do not have to be formed in end faces of the strengthened glass plate 1 connecting the both main surfaces. However, when the compressive stress layers are formed over the end faces, the strengthened glass plate 1 with higher strength can be formed.

The aforementioned compressive stress will be referred to as CS (Compressive Stress) [MPa]. The aforementioned tensile stress will be referred to as CT (Central Tension) [MPa]. The depth of the compressive stress layer (depth from the glass surface layer to a point where CS reaches zero in a thickness direction) will be referred to as DOL (Depth Of Layer) [μm]. These three satisfy the following formula (3) when the thickness of the glass plate is t [μm]. Generally, when chemical strengthening is performed once, the CS is reduced substantially linearly from the surface layer, and reaches zero at DOL. Thus, it has been known that the following formula (1) is satisfied.

$$\begin{matrix}CT = \frac{2 \times {\int }_{0}^{DOL} CS ( x ) dx}{t - 2 \times DOL} & ( 3 ) \\ CT = \frac{CS \times DOL}{t - 2 \times DOL} & ( 1 )\end{matrix}$$

Typically a glass plate is often more excellent in strength as the CS and DOL are larger in the glass plate. However, with increase in the CS and DOL, the CT also increases. With increase of the CT, there may arise a problem that the glass plate becomes weaker against impact, or the glass plate is broken into small pieces and the pieces fly around. Therefore, a critical value where unacceptable vulnerability begins to appear is obtained experimentally, and CTₗᵢₘᵢₜ may be used. The CTₗᵢₘᵢₜ is defined by CTₗᵢₘᵢₜ=−38.7× ln(t/1000)+48.2 [MPa], which is disclosed as an upper limit of the tensile stress CT at the plate thickness t [μm]. On the other hand, it has been found that the aforementioned formula cannot be used when the CT obtained by the above formula (1) is less than 85% of the CT obtained by the above formula (3) in such a case that chemical strengthening is performed a plurality of times. In that case, an idea of specific energy density rE [kJ/m²] obtained by the relation of a ratio between the area where the tensile stress CT acts and the plate thickness may be used. The specific energy density rE can be obtained by the following formula (2) using the plate thickness t [μm], the CT [MPa] obtained by the above formula (1), and the DOL [μm]. An upper limit rEₗᵢₘᵢₜ of the specific energy density rE may be obtained as follows: rEₗᵢₘᵢₜ=23.3×t/1000+15 [kJ/m²].

$$rE = \frac{CT \times {( t - 2 \times DOL )}^{2}}{1000 \times t} \qquad ( 2 )$$

It is preferable that the CT is made as close to the CTₗᵢₘᵢₜ as possible when chemically strengthened glass is produced. However, strengthening is performed in consideration of a variation in processes so that the CT can be prevented from exceeding the critical value CTₗᵢₘᵢₜ but can be made about 80% of the CTₗᵢₘᵢₜ.

When chemically strengthened glass which has been chemically strengthened a plurality of times is produced, it is preferable that the rE is made as close to the rEₗᵢₘᵢₜ as possible. However, strengthening is performed in consideration of a variation in processes so that the rE can be prevented from exceeding the critical value rEₗᵢₘᵢₜ but can be made about 80% of the rEₗᵢₘᵢₜ.

As for a glass plate having no functional layer, CS, DOL and a distribution of compressive stress is measured after strengthening under specific conditions. The result of the measurement is fed back to set new strengthening conditions so that a strengthened glass plate having the CT or rE close to CTₗᵢₘᵢₜ or rEₗᵢₘᵢₜ can be produced.

On the other hand, as for a glass plate having functional layers on both main surfaces of the glass plate, the CS cannot be measured. It is therefore typical to perform strengthening so that the CT or rE can be conveniently made about 80% of the CTₗᵢₘᵢₜ or rEₗᵢₘᵢₜ of a glass plate having no functional layer.

The present inventors reconsidered strengthening conditions or the like through accurately measuring compressive stress in a strengthened glass plate having functional layers on both main surfaces thereof. Then, the present inventors succeeded in producing a strengthened glass plate whose CT or rE was made closer to CTₗᵢₘᵢₜ or rEₗᵢₘᵢₜ than the cases in background-art products. Specifically, the strengthened glass plate according to the embodiment is a strengthened glass plate including functional layers on both main surfaces thereof, and satisfying the following relation: CT>0.8×CTₗᵢₘᵢₜ or rE>0.8×rEₗᵢₘᵢₜ. In the strengthened glass plate, more preferably, the following relation is satisfied: CT>0.9×CTₗᵢₘᵢₜ or rE>0.9×rEₗᵢₘᵢₜ; and further more preferably, the following relation is satisfied: CT>0.95×CTₗᵢₘᵢₜ or rE>0.95×rEₗᵢₘᵢₜ. As the CT is closer to the CTₗᵢₘᵢₜ, or as the rE is closer to the rEₗᵢₘᵢₜ, a margin of the CS or DOL can be increased so that the glass can be made more excellent in strength.

The strengthened glass plate according to the embodiment may be a flat glass plate or a glass plate subjected to bending processing. It is preferable that the strengthened glass plate according to the embodiment is formed by an existing glass forming method such as a float method, a fusion method or a slot down draw method so that the strengthened glass plate can have a liquid phase viscosity of 130 dPa·s or more.

The plate thickness t of the strengthened glass plate according to the embodiment is preferably 100 μm to 3,500 μm, and more preferably 100 μm to 1,500 μm for weight reduction. In addition, it is preferable that a maximum error of the plate thickness t, that is, a difference between thickness of a thickest part of the plate thickness and thickness of a thinnest part of the plate thickness is not higher than 10% of the plate thickness t. When the maximum error of the plate thickness is large, there is a fear that the glass plate may be cracked easily due to tensile stress locally growing within its surface in response to external force applied thereto. It is more preferable that the maximum error of the plate thickness t is not higher than 5%.

The strengthened glass plate according to the embodiment can be used as a cover glass or touch sensor glass of a touch panel display provided in an information apparatus such as a tablet PC, a notebook PC, a smartphone, an electronic book reader, etc., a cover glass of a liquid crystal television, a PC monitor, etc., a cover glass of an instrument panel of an automobile or the like, a window (front, rear, door, roof, etc.) of an automobile, a cover glass for solar cells, an interior finishing material as a housing material, a multi-layer glass for use in a window of a building or a house, etc.

The strengthened glass plate according to the embodiment is typically cut into a rectangular shape. However, there is no problem in the strengthened glass plate having another shape such as a circular shape or a polygonal shape. Perforated glass may be included.

Surface compressive stress (CS) in the strengthened glass plate according to the embodiment is preferably 400 MPa or more, more preferably 500 MPa or more, further more preferably 700 MPa or more, and especially preferably 900 MPa or more. This is because an error of the CT during measurement increases as the CS is larger.

Depth (DOL) in the compressive stress layer of the strengthened glass plate according to the embodiment is preferably 5 μm or more, more preferably 10 μm or more, further more preferably 20 μm or more, especially preferably 30 μm or more, and most preferably 40 μm or more. This is because an error of the CT during measurement increases as the DOL is larger so that errors of the CT and the rE can be increased.

(Surface Refractive Index Measuring Apparatus)

FIG. 2 is a view showing a surface refractive index measuring apparatus according to the embodiment. As shown in FIG. 2, according to the embodiment of the present invention in FIG. 2, a surface refractive index measuring apparatus 100 has a light source 10, a light input/output member 20, a liquid 30, an optical conversion member 40, a polarizing member 50, an imaging device 60, and an arithmetic operation portion 70.

The reference numeral 200 represents a strengthened glass plate as an object to be measured. The strengthened glass plate 200 is, for example, glass which has been subjected to strengthening treatment by a chemically strengthening method, an air-quench strengthening method, or the like. The strengthened glass plate 200 has a functional layer on its surface 210 side. The functional layer has a refractive index distribution. The functional layer includes a compressive stress layer and a tensile stress layer. The compressive stress layer is located at least on the glass surface side. In the compressive stress layer, compressive stress has occurred due to ion exchange. The tensile stress layer is located on the glass inside and next to the compressive stress layer. In the tensile stress layer, tensile stress has occurred.

The light source 10 is disposed so that a light beam L can enter the functional layer of the strengthened glass plate 200 from the light input/output member 20 through the liquid 30. In order to use interference, the wavelength of the light source 10 is preferably a single wavelength serving for simple contrast display.

For example, an Na lamp capable of obtaining single-wavelength light easily can be used as the light source 10. The wavelength in this case is 589.3 nm. Alternatively, a mercury lamp having a shorter wavelength than the Na lamp may be used. The wavelength in this case is, for example, 365 nm, corresponding to mercury I-line. Since the mercury lamp has a lot of emission lines, it is preferable that the mercury lamp is used through a band pass filter for transmitting only the 365 nm line.

Alternatively, an LED (Light Emitting Diode) may be used as the light source 10. In recent years, LEDs of many wavelengths have been developed. The spectrum width of any LED is not shorter than 10 nm in half width. The LED is poor in single wavelength characteristic, and the wavelength of the LED varies depending on the temperature. It is therefore preferable that the LED is used through a band pass filter.

When the light source 10 has a configuration in which light from an LED is passed through a band pass filter, the light source 10 is poorer in single wavelength characteristic than the Na lamp or the mercury lamp. However, any wavelength from an ultraviolet region to an infrared region can be used preferably. The wavelength of the light source 10 has no influence on the fundamental principles of measurement in the surface refractive index measuring apparatus 1. Therefore, a light source having another wavelength than the aforementioned wavelength example may be used.

The light input/output member 20 is mounted on the surface 210 of the strengthened glass plate 200, which is an object to be measured. The light input/output member 20 has two functions, that is, a function of allowing light to enter the functional layer of the strengthened glass plate 200 from a slope 21 side, and a function of allowing the light propagated through the strengthened glass plate 200 to be emitted from a slope 22 side to the outside of the strengthened glass plate 200.

The liquid 30 is charged between the light input/output member 20 and the strengthened glass plate 200. The liquid 30 is an optically coupling liquid for optically coupling a bottom surface 23 (first surface) of the light input/output member 20 with the surface 210 of the strengthened glass plate 200. That is, the bottom surface 23 of the light input/output member 20 is brought into contact with the surface 210 of the strengthened glass plate 200 through the liquid 30.

For example, as for the liquid 30, 1-bromonaphthalen (n=1.660) and liquid paraffin (n=1.48) are mixed at an appropriate ratio so that a liquid with a refractive index from 1.48 to 1.66 can be obtained. The refractive index of the mixed liquid varies linearly in proportion to the mixture ratio. For example, the refractive index of the liquid is measured by DR-A1 Abbe Refractometer (measuring accuracy 0.0001) made by Atago, Co, Ltd. or the like, and the mixture ratio is adjusted accordingly. Thus, a liquid having an accurate refractive index can be obtained.

A prism made of optical glass can be, for example, used as the light input/output member 20. In this case, a light beam is incident on and exit from the surface 210 of the strengthened glass plate 200 through the prism optically. Therefore, the refractive index of the prism should be made larger than the refractive index of the liquid 30 and the refractive index of the strengthened glass plate 200. In addition, the refractive index should be selected so that the incident light and the outgoing light can pass substantially perpendicularly in the slopes 21 and 22 of the prism.

For example, when the inclination angle of the prism is 60° and the refractive index of the functional layer of the strengthened glass plate 200 is 1.52, the refractive index of the prism can be set at 1.72. On the other hand, optical glass as a material of the prism has high uniformity in refractive index. For example, in-plane deviation of the refractive index can be suppressed to be 1×10⁻⁵ or less.

As the light input/output member 20, another member having similar functions may be used in place of the prism. Even when any member is used as the light input/output member 20, it is desired that the in-plane deviation of the refractive index in the bottom surface 23 of the light input/output member 20 is suppressed to be 1×10⁻⁵ or less within a region of an image obtained in an imaging step, which will be described later. In addition, it is preferable that flatness of the bottom surface 23 of the light input/output member 20 is formed to be not higher than λ/4 when λ is the wavelength of the light from the light source 10. It is more preferable that the flatness is formed to be not higher than λ/8.

The imaging device 60 is disposed in a direction of the light emitted from the slope 22 side of the light input/output member 20. The optical conversion member 40 and the polarizing member 50 are inserted between the light input/output member 20 and the imaging device 60.

The optical conversion member 40 has the following function. That is, by the optical conversion member 40, the light beam emitted from the slope 22 side of the light input/output member 20 can be converted into a set of emission lines, and collected onto the imaging device 60. For example, a convex lens can be used as the optical conversion member 40. However, another member having a similar function may be used.

The polarizing member 50 is a light separation unit having a function of transmitting one selectively from two kinds of light components oscillating in parallel with and perpendicularly to a boundary surface between the strengthened glass plate 200 and the liquid 30. As the polarizing member 50, for example, a polarization plate or the like disposed rotatably can be used. However, another member having a similar function may be used. Here, the light component oscillating in parallel with the boundary surface between the strengthened glass plate 200 and the liquid 30 is S-polarized light, and the light component oscillating perpendicularly thereto is P-polarized light.

The boundary surface between the strengthened glass plate 200 and the liquid 30 is perpendicular to an emission surface of the light emitted to the outside of the strengthened glass plate 200 through the light input/output member 20. To say other words, the light component oscillating perpendicularly to the emission surface of the light emitted to the outside of the strengthened glass plate 200 through the light input/output member 20 is S-polarized light, and the light component oscillating in parallel therewith is P-polarized light.

The imaging device 60 has the following function. That is, by the imaging device 60, the light emitted from the light input/output member 20 and received through the optical conversion member 40 and the polarizing member 50 can be converted into an electric signal. More in detail, the imaging device 60 can convert the received light into an electric signal, and supply image data to the arithmetic operation portion 70. The image data includes luminance values of a plurality of pixels forming an image. As the imaging device 60, for example, a device such as a CCD (Charge Coupled Device) or a CMOS (Complementary Metal Oxide Semiconductor) can be used. However, another device having a similar function may be used.

The arithmetic operation portion 70 has a function of importing the image data from the imaging device 60, and performing image processing and numerical calculation on the image data. The arithmetic operation portion 70 may also have another function (for example, a function of controlling a light volume or an exposure time of the light source 10). The arithmetic operation portion 70 can be, for example, configured to include a CPU (Central Processing Unit), a ROM (Read Only Member), a RAM (Random Access Memory), a main memory, etc.

In this case, various functions of the arithmetic operation portion 70 can be implemented by programs recorded in the ROM or the like. The programs are read out on the main memory, and executed by the CPU. The CPU of the arithmetic operation portion 70 can read data from the RAM or store data therein in accordance with necessity. However, a part or all of the arithmetic operation portion 70 may be implemented only by hardware. The arithmetic operation portion 70 may be physically configured by a plurality of devices. As the arithmetic operation portion 70, for example, a personal computer can be used.

In the surface refractive index measuring apparatus 1, the light L incident on the slope 21 side of the light input/output member 20 from the light source 10 enters the functional layer of the strengthened glass plate 200 through the liquid 30. Thus, the light L becomes a guided light propagated inside the functional layer. When the guided light is propagated inside the functional layer, modes occur due to a light waveguide effect. Thus, after going through some determined paths, the guided light is emitted from the slope 22 side of the light input/output member 20 to the outside of the strengthened glass plate 200.

Then, due to the optical conversion member 40 and the polarizing member 50, the guided light forms an image as emission lines of P-polarized light and S-polarized light for each mode on the imaging device 60. Image data of a number of emission lines of P-polarized light and S-polarized light corresponding to the number of modes occurring on the imaging device 60 are sent to the arithmetic operation portion 70. In the arithmetic operation portion 70, positions of the emission lines of the P-polarized light and the S-polarized light on the imaging device 60 are calculated from the image data sent from the imaging device 60.

Due to such a configuration, in the surface refractive index measuring apparatus 1, respective refractive index distributions of P-polarized light and S-polarized light in a depth direction from the surface in the functional layer of the strengthened glass plate 200 can be calculated based on the positions of the emission lines of the P-polarized light and the S-polarized light.

Thus, a stress distribution in the depth direction from the surface in the functional layer of the strengthened glass plate 200 can be calculated based on a difference between the respective calculated refractive index distributions of the P-polarized light and the S-polarized light, and the photoelastic constant of the strengthened glass plate 200.

In addition, in the surface refractive index measuring apparatus 1, the liquid 30 as optically coupling liquid is charged between the light input/output member 20 and the strengthened glass plate 200, and the refractive index of the liquid 30 is adjusted to be equivalent to the refractive index of the functional layer of the strengthened glass plate 200. In addition, a distance d (thickness of the liquid 30) between the bottom surface 23 of the light input/output member 20 and the surface 210 of the strengthened glass plate 200 opposed to each other is 5 microns or less. In addition, the in-plane deviation of the refractive index in the bottom surface 23 of the light input/output member 20 is suppressed to be 1×10⁻⁵ or less, and the flatness of the bottom surface 23 is made not higher than about ¼ of the wavelength λ of the light from the light source 10. Thus, due to the high optical uniformity, ideal reflection can be obtained.

Thus, reflection or refraction does not occur at all in the interface between the surface of the strengthened glass plate 200 and the liquid 30, but the interface between the bottom surface 23 of the light input/output member 20 and the liquid 30 can be used as one reflecting surface of guided light so that the guided light can be obtained intensively. That is, while guided light is reflected on surfaces of a strengthened glass plate in the background-art apparatus, one of the reflections can be replaced by reflection on the bottom surface 23 of the light input/output member 20 having an optically ideal surface. Thus, intensive guided light can be obtained.

As a result, even in a strengthened glass plate which is poor in optical surface flatness or even in a strengthened glass plate which is poor in uniformity as to the refractive index of a surface, intensive guided light can be obtained independently of the state of the surface of the strengthened glass plate. Thus, clear emission lines can be obtained so that a refractive index distribution in a functional layer of the strengthened glass plate can be measured accurately in a non-destructive manner.

### (Surface Refractive Index Measuring Method)

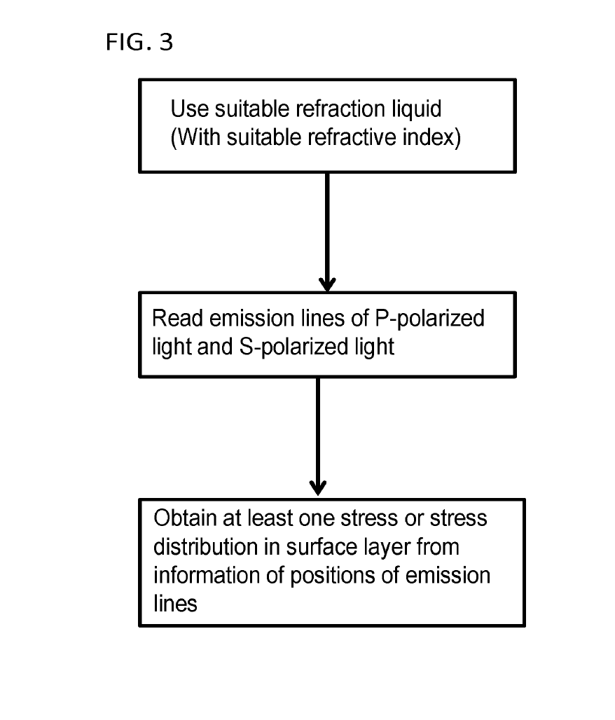

Description will be made below as to a flow of measurement of stress in the strengthened glass plate according to the embodiment. FIG. 3 is a flow chart showing an example of a measuring method according to the embodiment. As shown in FIG. 3, according to the embodiment, a glass and a prism are brought into contact with each other through a suitable thickness using a suitable refraction liquid having a suitable refractive index, and emission lines of P-polarized light and S-polarized light are read out. At least one stress or stress distribution in a functional layer is obtained from information of positions of the emission lines read thus.

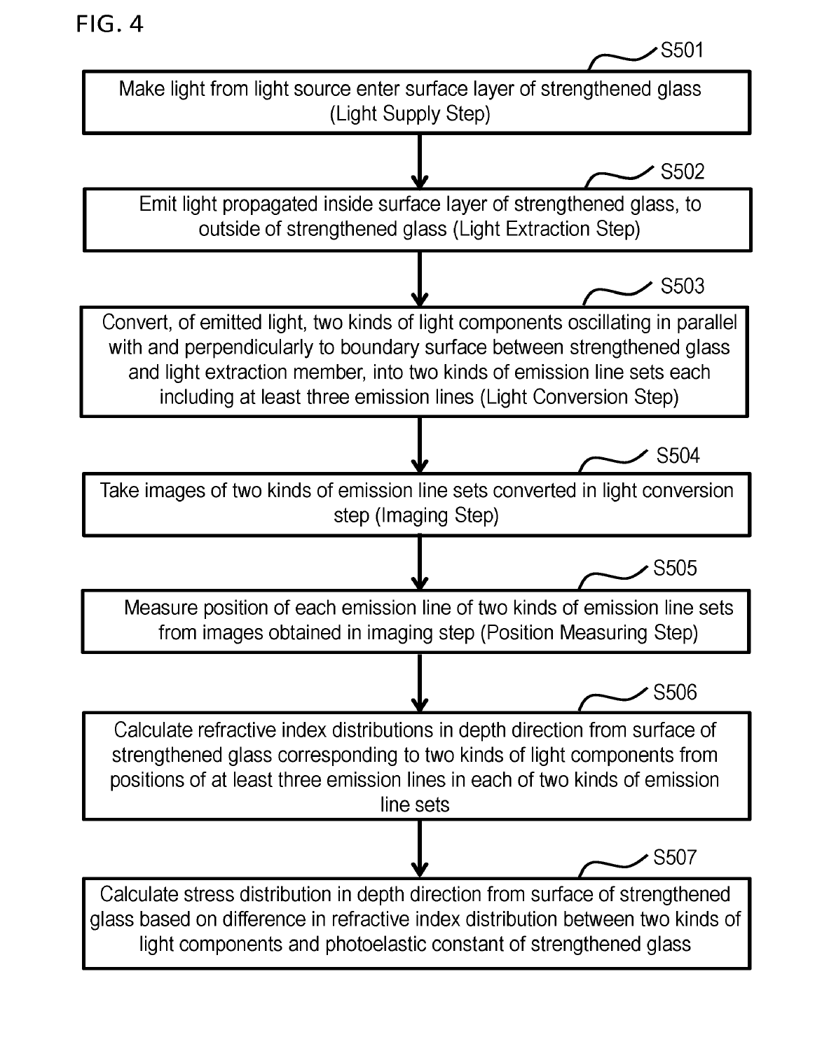

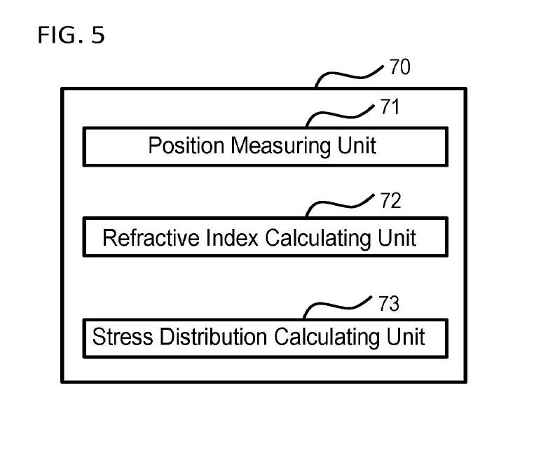

FIG. 4 is a flow chart showing the measuring method according to the embodiment. FIG. 5 is a diagram showing functional blocks of the arithmetic operation portion 70 of the surface refractive index measuring apparatus 1.

First, in Step S501, light from the light source 10 is made to enter the functional layer of the strengthened glass plate 200 (light supply step). Next, in Step S502, the light propagated inside the functional layer of the strengthened glass plate 200 is emitted to the outside of the strengthened glass plate 200 (light extraction step).

Next, in Step S503, the optical conversion member 40 and the polarizing member 50 converts, of the emitted light, two kinds of light components (P-polarized light and S-polarized light) oscillating in parallel with and perpendicularly to the emission surface, into two kinds of emission line sets each including at least two emission lines (light conversion step).

Next, in Step S504, the imaging device 60 takes images of the two kinds of emission line sets converted in the light conversion step (imaging step). Next, in Step S505, a position measuring unit 71 of the arithmetic operation portion 70 measures a position of each emission line of the two kinds of emission line sets from the images obtained in the imaging step (position measuring step).

Next, in Step S506, a refractive index distribution calculating unit 72 of the arithmetic operation portion 70 calculates refractive index distributions in the depth direction from the surface 210 of the strengthened glass plate 200 corresponding to the two kinds of light components, from the positions of the at least two emission lines in each of the two kinds of emission line sets (refractive index distribution calculating step). When each of the emission line sets includes three or more emission lines, refractive index distributions are derived not as straight lines but as curved lines.

Next, in Step S507, a stress distribution calculating unit 73 of the arithmetic operation portion 70 calculates a stress distribution in the depth direction from the surface 210 of the strengthened glass plate 200 based on a difference between the refractive index distributions of the two kinds of light components and a photoelastic constant of the glass (stress distribution calculating step). The processing in Step S507 is not required when it is intended to calculate only the refractive index distributions.

The profile of each refractive index distribution is similar to the profile of the stress distribution. Therefore, in Step S507, the stress distribution calculating unit 73 may calculate, as the stress distribution, of the refractive index distributions corresponding to P-polarized light and S-polarized light, any one of the refractive index distribution corresponding to the P-polarized light, the refractive index distribution corresponding to the S-polarized light, and a refractive index distribution of an average value of the refractive index distribution corresponding to the P-polarized light and the refractive index distribution corresponding to the S-polarized light.

In this manner, according to the surface refractive index measuring apparatus and the surface refractive index measuring method according to the embodiment, refractive index distributions in the depth direction from a surface of a strengthened glass plate corresponding to two kinds of light components can be calculated from positions of at least two emission lines in each of two kinds of emission line sets.

Further, a stress distribution in the depth direction from the surface of the strengthened glass plate can be calculated based on a difference between the refractive index distributions of the two kinds of light components and a photoelastic constant of the glass. That is, the refractive index distributions and the stress distribution in the functional layer of the strengthened glass plate can be measured in a non-destructive manner.

### Examples and Comparative Examples

In Examples and Comparative Examples, emission lines were observed in a background-art method and a new measuring method as to soda lime glass (Comparative 1), aluminosilicate glass (Comparative 2), soda lime glass in which tin (Sn) had been diffused in a surface (Comparative 3 and Example 1), soda lime glass in which silver (Ag) had been diffused in a surface (Comparative 4 and Example 2), and antiglare glass with large surface roughness (Comparative 5, Comparative 6, Example 3 and Example 4).

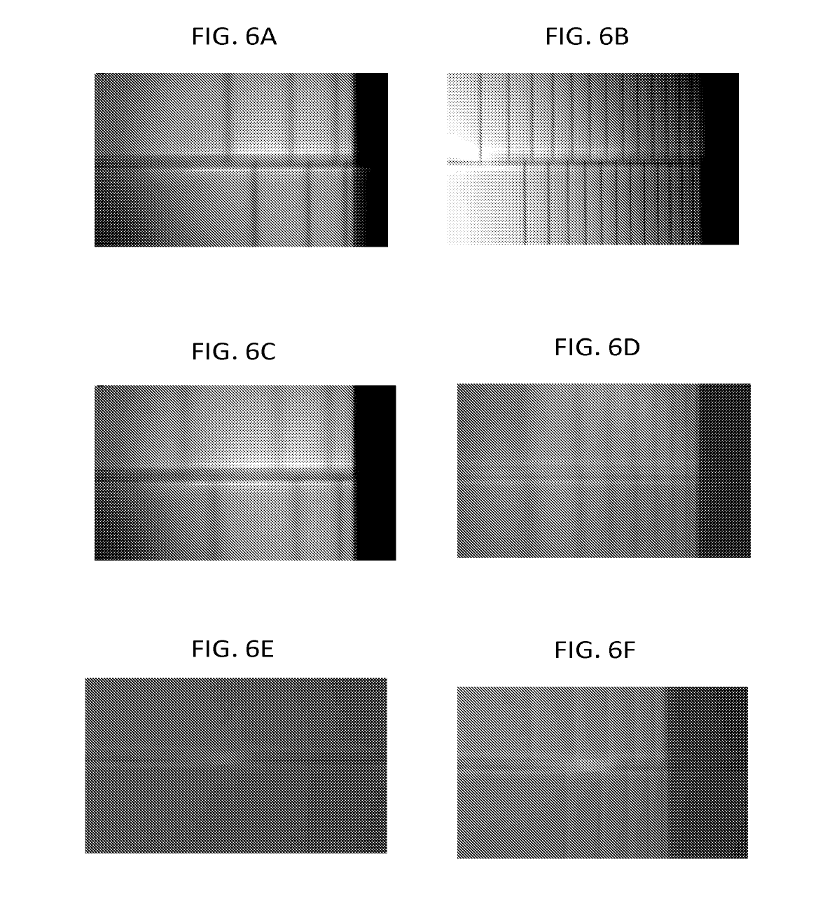

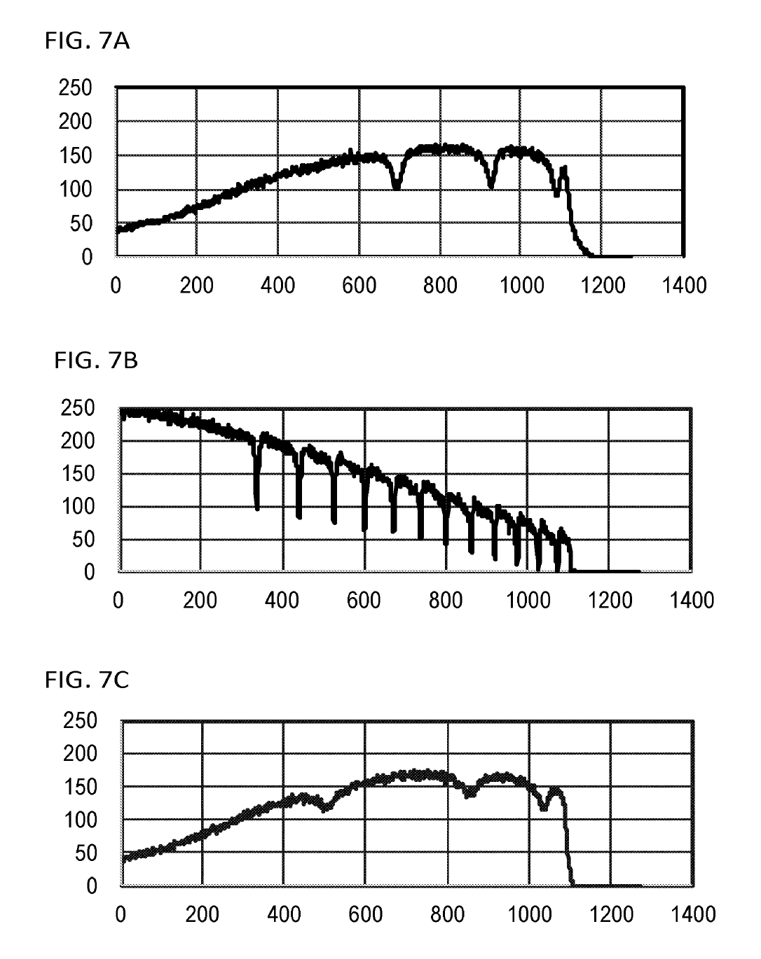

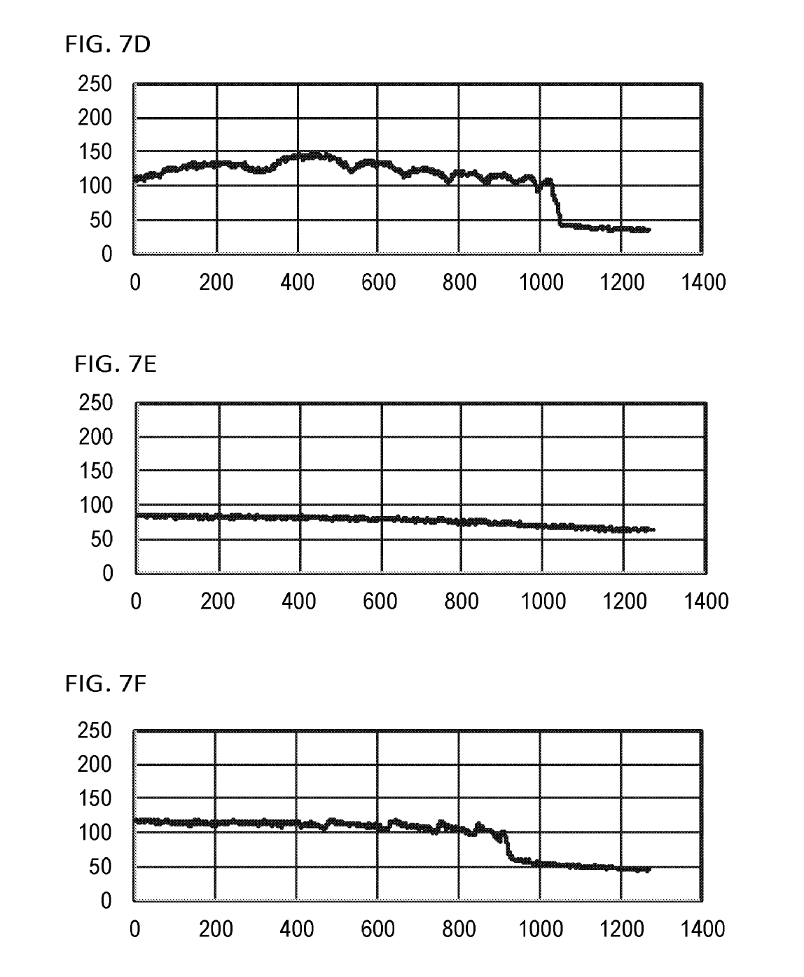

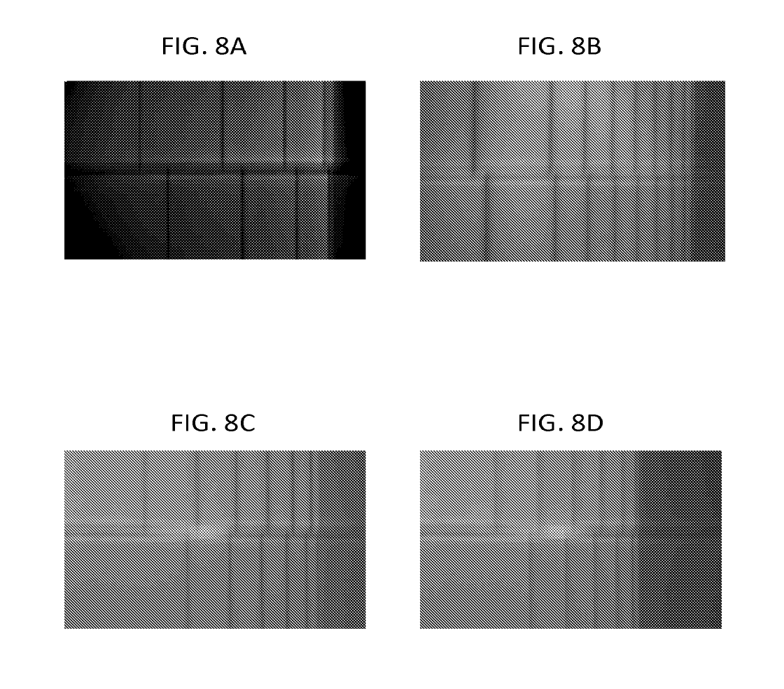

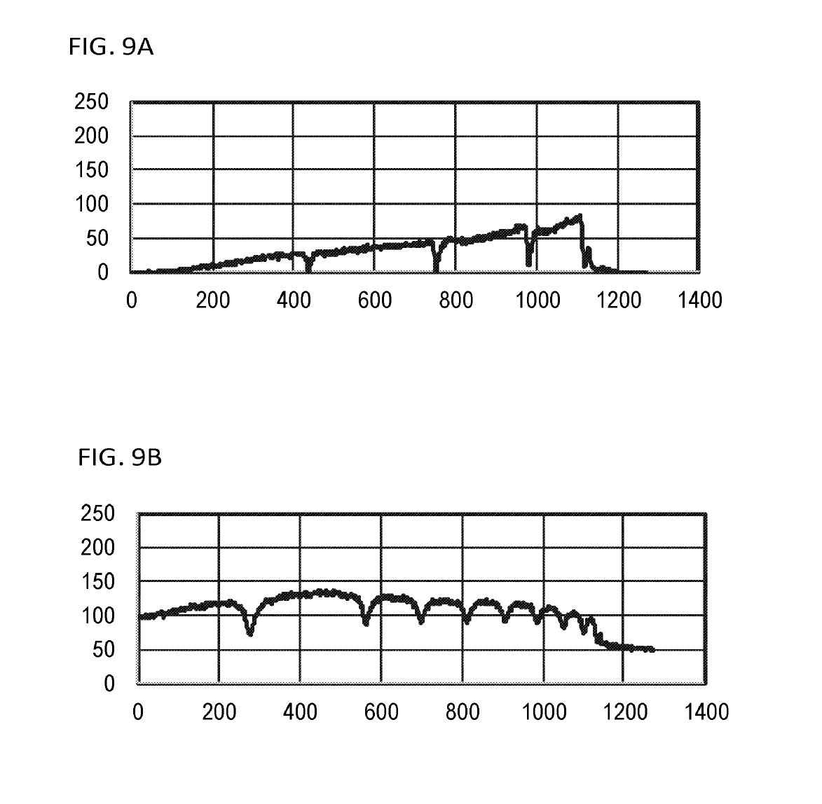

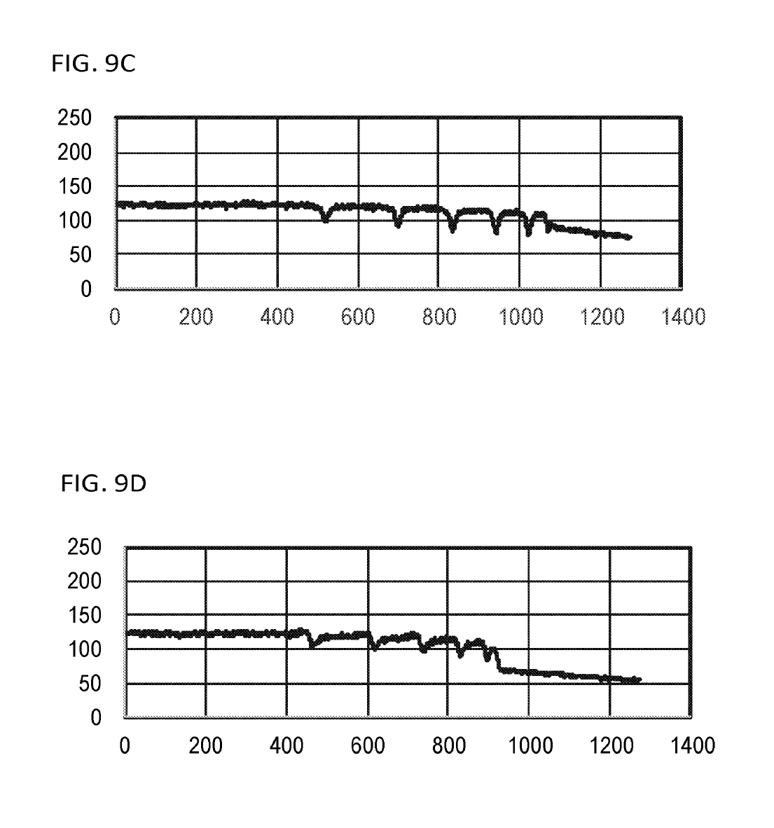

Here, the new measuring method designates the case in which ngb<nf≤ngs+0.005 in the surface refractive index measuring method described in the aforementioned embodiment, and the background-art method designates the case in which ngs+0.005<nf. Results of Comparative Examples are shown in Table 1, and results of Examples are shown in Table 2. The photos of emission lines in Comparative Examples 1 to 6 are shown in FIG. 6A to FIG. 6F, respectively. The graphs showing brightness of emission lines in which brightness on the upper side of the photo of the emission lines is expressed by 256 colors in Comparative Examples 1 to 6 are shown in FIG. 7A to FIG. 7F, respectively. The photos of emission lines in Examples 1 to 4 are shown in FIG. 8A to FIG. 8D, respectively. The graphs showing brightness of emission lines in which brightness on the upper side of the photo of the emission lines is expressed by 256 colors in Examples 1 to 4 are shown in FIG. 9A to FIG. 9D, respectively.

TABLE 1

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| np | 1.720 | 1.720 | 1.720 | 1.720 | 1.720 | 1.720 |
| nf | 1.640 | 1.640 | 1.640 | 1.640 | 1.640 | 1.640 |
| ngs | 1.525 | 1.515 | 1.525 | 1.530 | 1.515 | 1.515 |
| ngb | 1.518 | 1.510 | 1.518 | 1.518 | 1.510 | 1.510 |
| Metal in outermost | — | — | Sn | Ag | — | — |
| surface | | | | | | |
| Ra (nm) | 0.001 | 0.001 | 0.001 | 0.001 | 0.3 | 0.1 |
| Measuring method | Background-art | Background-art | Background-art | Background-art | Background-art | Background-art |
| | method | method | method | method | method | method |
| Photo of emission lines | FIG. 6A | FIG. 6B | FIG. 6C | FIG. 6D | FIG. 6E | FIG. 6F |
| Brightness of emission | FIG. 7A | FIG. 7B | FIG. 7C | FIG. 7D | FIG. 7E | FIG. 7F |
| lines (upper side) | | | | | | |
| Half width of emission | 41 microns | 14 microns | 199 microns | 319 microns | Impossible to | Impossible to |
| lines | | | | | measure; and | measure; and |
| CS variation | ±41 MPa | ±14 MPa | ±97 MPa | ±155 MPa | thin emission | white and black |
| | | | | | lines | emission lines |
| Final judge | ◯ | ◯ | X | X | X | X |

TABLE 2

| | Example 1 | | Example 2 | | Example 3 | | Example 4 | |
|---|---|---|---|---|---|---|---|---|
| np | 1.720 | | 1.720 | | 1.720 | | 1.720 | |
| nf | 1.520 | | 1.530 | | 1.514 | | 1.518 | |
| ngs | 1.525 | | 1.530 | | 1.515 | | 1.515 | |
| ngb | 1.518 | | 1.518 | | 1.510 | | 1.510 | |
| Metal in | Sn | | Ag | | — | | — | |
| outermost | | | | | | | | |
| surface | | | | | | | | |
| Ra(nm) | 0.001 | | 0.001 | | 0.3 | | 0.1 | |
| Measuring | New measuring | | New measuring | | New measuring | | New measuring | |
| method | method | | method | | method | | method | |
| Photo of | FIG. 8A | | FIG. 8B | | FIG. 8C | | FIG. 8D | |
| emission lines | | | | | | | | |
| Brightness of | FIG. 9A | | FIG. 9B | | FIG. 9C | | FIG. 9D | |
| emission lines | | | | | | | | |
| (upper side) | | | | | | | | |
| Half width of | 42 | microns | 102 | microns | 65 | microns | 60 | microns |
| emission lines | | | | | | | | |
| CS variation | ±20 | MPa | ±50 | MPa | ±32 | MPa | ±29 | MPa |

| | | | | |
|---|---|---|---|---|
| Final judge | ◯ | ◯ | ◯ | ◯ |

In Table 1 and Table 2, np is a refractive index of the light input/output member 20, of is a refractive index of the liquid 30, ngs is a refractive index in the outermost surface of the strengthened glass plate 200, ngb is a refractive index of glass in the strengthened glass plate 200 before a strengthening step, and Ra is surface roughness (arithmetic average roughness Ra) of the strengthened glass plate 200. In addition, the photo of emission lines is image data sent from the imaging device 60, and the brightness of the emission lines is a graph in which brightness on the upper side of the photo of the emission lines is expressed by 256 colors, the abscissa of the graph designating the brightness, the ordinate of the graph designating a position in a width direction of the photo. Positions of stripes are read automatically or manually from a waveform of the graph. The half width of the emission lines designates a width in which a maximum and a minimum in a valley shape of the brightness of the emission lines varying in accordance with the emission lines are halved. The half width was derived from the brightness of the leftmost emission line having great influence when a CS in the outermost surface was derived. A large half width of the emission lines leads to an error in reading the positions of the emission lines. The CS variation designates an amount of change in the CS caused by the error in reading.

Here, each of CS and DOL was measured on each sample five times at different places as to Comparative Examples where emission lines could be observed barely by the background-art method and Examples using the new measuring method. Results of CT and CT/CTₗᵢₘᵢₜ obtained from plate thickness are shown in Table 3, Table 4 and Table 5. Similar samples each having a plate thickness of 3,320 μm were used in Comparative 3 and Example 1. Similar samples each having a plate thickness of 1,000 μm were used in Comparative 5 and Example 3. Similar samples each having a plate thickness of 3,100 μm were used in Comparative 6 and Example 4. The CTₗᵢₘᵢₜ was obtained from the following formula: CTₗᵢₘᵢₜ=−38.7×ln(t/1000)+48.2 [MPa]. Here, t is the plate thickness [μm]. Ave is an average value of five measurements, and S.D. is a standard deviation of the five measurements. S.D. (%) is a ratio obtained by dividing S.D. by Ave.

TABLE 3

| | Measurement | | | | Measurement | | | |
|---|---|---|---|---|---|---|---|---|
| | result of Comparative 3 | | | | result of Example 1 | | | |
| | | | | CT/ | | | | CT/ |
| | CS | DOL | CT | CTₗᵢₘᵢₜ | CS | DOL | CT | CTₗᵢₘᵢₜ |
| N = 1 | 756.3 | 5.9 | 1.35 | 0.77 | 726.0 | 7.1 | 1.68 | 0.95 |
| N = 2 | 705.5 | 5.4 | 1.14 | 0.65 | 735.6 | 7.2 | 1.71 | 0.97 |
| N = 3 | 865.9 | 6.8 | 1.77 | 1.01 | 732.2 | 7.2 | 1.70 | 0.96 |
| N = 4 | 778.5 | 6.0 | 1.40 | 0.79 | 737.7 | 7.1 | 1.69 | 0.96 |
| N = 5 | 799.5 | 5.9 | 1.43 | 0.81 | 736.7 | 7.1 | 1.70 | 0.96 |
| Ave | 781.1 | 6.0 | 1.42 | 0.81 | 733.6 | 7.1 | 1.70 | 0.96 |
| S.D. | 58.86 | 0.51 | 0.23 | 0.13 | 4.74 | 0.05 | 0.01 | 0.01 |
| S.D | 8% | 8% | 16% | 16.1% | 1% | 1% | 1% | 0.8% |
| (%) | | | | | | | | |

TABLE 4

| | Measurement | | | | Measurement | | | |
|---|---|---|---|---|---|---|---|---|
| | result of Comparative 5 | | | | result of Example 3 | | | |
| | | | | CT/ | | | | OT/ |
| | CS | DOL | CT | CTₗᵢₘᵢₜ | CS | DOL | CT | CTₗᵢₘᵢₜ |
| N = 1 | N.D. | N.D. | N.D. | N.D. | 802.0 | 49.7 | 44.28 | 0.92 |
| N = 2 | N.D. | N.D. | N.D. | N.D. | 807.3 | 50.4 | 45.20 | 0.94 |
| N = 3 | N.D. | N.D. | N.D. | N.D. | 779.7 | 51.0 | 44.29 | 0.92 |
| N = 4 | N.D. | N.D. | N.D. | N.D. | 782.1 | 51.0 | 44.46 | 0.92 |
| N = 5 | N.D. | N.D. | N.D. | N.D. | 772.3 | 51.0 | 43.88 | 0.91 |
| Ave | N.D. | N.D. | N.D. | N.D. | 788.7 | 50.6 | 44.42 | 0.92 |
| S.D. | N.D. | N.D. | N.D. | N_D. | 15.14 | 0.59 | 0.48 | 0.01 |
| S.D (%) | N.D. | N.D. | N.D. | N.D. | 1.9% | 1.2% | 1.1% | 1.1% |

TABLE 5

| | Measurement | | | | Measurement | | | |
|---|---|---|---|---|---|---|---|---|
| | result of Comparative 6 | | | | result of Example 4 | | | |
| | CS | DOL | CT | CT/CTₗᵢₘᵢₜ | CS | DOL | CT | CT/CTₗᵢₘᵢₜ |
| N = 1 | 814.5 | 15.1 | 4.01 | 0.91 | 804.3 | 15.8 | 4.14 | 0.94 |
| N = 2 | 796.2 | 15.8 | 4.09 | 0.93 | 816.2 | 15.8 | 4.20 | 0.95 |
| N = 3 | 850.9 | 15.6 | 4.31 | 0.98 | 811.2 | 15.9 | 4.20 | 0.95 |
| N = 4 | 746.4 | 15.1 | 3.68 | 0.83 | 810.2 | 15.8 | 4.17 | 0.95 |
| N = 5 | 953.6 | 15.5 | 4.81 | 1.09 | 796.8 | 15.9 | 4.13 | 0.93 |
| Ave | 832.3 | 15.4 | 4.18 | 0.95 | 807.8 | 15.8 | 4.17 | 0.94 |
| S.D. | 77.53 | 0.28 | 0.42 | 0.10 | 7.44 | 0.05 | 0.03 | 0.01 |
| S.D (%) | 9.3% | 1.8% | 10.1% | 10.1% | 0.9% | 0.3% | 0.8% | 0.8% |

As shown in Table 3 or Table 5, there was a wide variation among measurements in Comparative 3 or Comparative 6, and the case of the CT exceeding the CTₗᵢₘᵢₜ was observed. Industrially, a product in which CT exceeds CTₗᵢₘᵢₜ cannot be shipped because safety cannot be confirmed. Therefore, according to the measurement results of Comparative 3 or Comparative 6, products could not be shipped, and products could not be produced under the conditions. It was therefore necessary to change chemically strengthening conditions etc. to thereby provide treatment for reducing the CT. Thus, the CT/CTₗᵢₘᵢₜ having the widest variation had to be reduced to 0.8 or less to thereby secure safety. However, when the same product is measured by the new measuring method, the measurement results of Example 1 or Example 4 can be obtained, and it can be confirmed that CT does not exceed CTₗᵢₘᵢₜ. Thus, the product can be produced without reducing strength.

As shown in Table 4, in Comparative 5 in which emission lines is hardly observed by the background-art method, CS and DOL cannot be confirmed at all. Due to N.D. (No Data), safety cannot be confirmed. Therefore, the CS or DOL cannot be increased sufficiently to make CT close to CTₗᵢₘᵢₜ. Thus, glass with high strength cannot be shipped. However, according to the new measuring method, emission lines can be observed clearly as in Example 3. Due to this effect, it can be confirmed that CT does not exceed CTₗᵢₘᵢₜ. Thus, the product can be produced without reducing strength.

In this manner, when a layer providing optical disturbance is provided in at least one surface while a layer providing optical disturbance is provided in the other surface in the same manner or a glass surface is prevented from being exposed in the other surface due to some coating, quality control is necessary in the layer providing optical disturbance. The method of the present invention is important to supply glass with high strength.

Here, the layer providing optical disturbance is a layer in which the half width of an emission line observed on the leftmost side is 150 μm or more when it is observed in the background-art method. Such a layer is a layer in which metal ions have been diffused in the surface or which has been treated to increase surface roughness.

In addition, the new measuring method is a surface refractive index measuring method described in the aforementioned embodiment, in which the following relation is established: ngb<nf≤ngs+0.005, while the background-art method is a similar surface refractive index measuring method in which the following relation is established: ngs+0.005<nf.

In this manner, when measurement is performed by the new measuring method, a variation of CS can be reduced to be 50 MPa or less. Thus, measurement can be performed with precision equivalent to or finer than that in normal chemically strengthened glass shown in Comparative 1 or Comparative 2. As a result, a glass plate in which the CT exceeds 80% of CTₗᵢₘᵢₜ can be produced out of a glass plate which has a functional layer and which cannot be produced in the background art.

In addition, when chemical strengthening is performed a plurality of times, a similar phenomenon can be confirmed on the rE proportional to the CT. Thus, a glass plate in which the rE exceeds 80% of rEₗᵢₘᵢₜ can be produced out of a glass plate which has a functional layer and which cannot be produced in the background art.

A preferred embodiment and Examples have been described above in detail. However, the present invention is not limited to the aforementioned embodiment and Examples. Various changes and replacements can be applied to the aforementioned embodiment and Examples without departing from the scope stated in the claims.

For example, in the aforementioned embodiment, a light source was described as a constituent element of the surface refractive index measuring apparatus. However, the surface refractive index measuring apparatus may be configured to include no light source. In this case, the surface refractive index measuring apparatus may be, for example, configured to include a light input/output member 20, a liquid 30, an optical conversion member 40, a polarizing member 50, an imaging device 60 and an arithmetic operation portion 70. A suitable light source prepared by a user of the surface refractive index measuring apparatus may be used.

### DESCRIPTION OF REFERENCE NUMERALS AND SIGNS

1, 200 Strengthened glass plate
2 First functional layer
3 Second functional layer
10 Light source
20 Light input/output member
21, 22 Slope
23 Bottom surface
30 Liquid
40 Optical conversion member
50 Polarizing member
60 Imaging device
70 Arithmetic operation portion
71 Position measuring unit
72 Refractive index distribution calculating unit
73 Stress distribution calculating unit
100 Surface refractive index measuring apparatus
210 Surface of strengthened glass plate

1. A strengthened glass plate, comprising:
a first functional layer provided in a first main surface of the strengthened glass plate; and
a second functional layer provided in a second main surface of the strengthened glass plate,
wherein
a stress CT in a tensile stress layer of the strengthened glass plate obtained by the formula (1),
$$CT = \frac{CS \times DOL}{t - 2 \times DOL} \qquad ( 1 )$$
satisfies:
CT>0.8×[−38.7×ln(t/1000)+48.2],
where t is a plate thickness [μm], CS is a compressive stress [MPa] in an outermost surface, and DOL is a depth [μm] from a glass surface to a point where the compressive stress reaches zero in a thickness direction.

2. The strengthened glass plate according to claim 1, wherein
the stress CT satisfies:
CT>0.9×[−38.7×ln(t/1000)+48.2].

3. The strengthened glass plate according to claim 2, wherein
the stress CT satisfies:
CT>0.95×[−38.7×ln(t/1000)+48.2].

4-6. (canceled)

7. The strengthened glass plate according to claim 1, wherein
at least one of the first functional layer and the second functional layer is a layer that provides optical disturbance.

8. (canceled)

9. The strengthened glass plate according to claim 7, wherein
the layer that provides optical disturbance is a roughened layer having an arithmetic average roughness Ra of 0.1 μm or more.

10. (canceled)

11. The strengthened glass plate according to claim 7, wherein
the layer that provides optical disturbance is doped with at least one element selected from the group consisting of Sn, Ag, Ti, Ni, Co, Cu and In.

12. (canceled)
